(19) United States
(12) Patent Application Publication
(10) Pub. No.: US 2019/0116781 A1
(43) Pub. Date: Apr. 25, 2019

(54) HUNTING DECOY

(71) Applicant: William Meadows, Shepardsville, KY (US)

(72) Inventor: William Meadows, Shepardsville, KY (US)

(21) Appl. No.: 15/788,799

(22) Filed: Oct. 19, 2017

(51) Int. Cl. A01M 31/06; A01M 31/00

(52) U.S. Cl. CPC A01M 31/06; G05D 1/0011; A01M 31/004; A01M 31/008

(57) ABSTRACT

A hunting decoy that includes: a motorized base; a speaker, where the speaker emits sounds and is mounted on the motorized base; a scent emitter within the motorized base; a faux animal covering; and a set of wheels. The set of wheels preferably includes four wheels. The sounds emitted by the decoy preferably includes a plurality of predetermined animal calls. The motorized base may be electrically powered and include a suspension system. A user uses a remote control device to control movement of the hunting decoy over a terrain.

### BACKGROUND OF THE INVENTION

### Field of Invention

The present invention relates to a motorized hunting decoy that utilizes sound and scent to attract game.

### Description of Related Art

Hunters use various types of decoys to assist in attracting game during their hunting expeditions. Many types of decoys are used in particular for small game such as ducks, birds and other ground animals such as rabbits or squirrels. These decoys use various types of techniques to attract game. In particular with respect to ducks decoy ducks are sometimes placed upon a lake area to attract other ducks. Further scents and sounds are used to also attract game. Various scents attract animals and certain calls are used to attract certain game such as birds or other types of game. As a result, continued development of various devices are utilized by hunters to attract game.

### SUMMARY OF THE INVENTION

The present invention relates to a hunting decoy that includes: a motorized base; a speaker, where the speacker emits sounds and is mounted on the motorized base; a scent emitter within the motorized base; a faux animal covering; and a set of wheels. The set of wheels preferably includes four wheels. The sounds emitted by the decoy preferably includes a plurality of predetermined animal calls. The motorized base may be electrically powered and include a suspension system. A user uses a remote control device to control movement of the hunting decoy over a terrain.

### BRIEF DESCRIPTION OF DRAWINGS

FIG. 1 depicts a side view of a motorized hunting decoy according to the present invention.

FIG. 2 depicts a perspective view of the motorized hunting decoy according to the present invention.

### DETAILED DESCRIPTION

The present invention relates to a motorized hunting decoy that includes a motorized base preferably on four wheels. These four wheels provide a means to maneuver the motorized decoy over terrain. Further a remote control is preferably used to control the decoy's movement. Other aspects of the motorized decoy include a speaker that emits sounds such as animal calls to attract game. In addition to animal calls a scent emitter is provided within the motorized base that emits a scent to further provide a means to attract game. The hunting decoy includes an animal skin or a faux animal covering as a visual means to attract game.

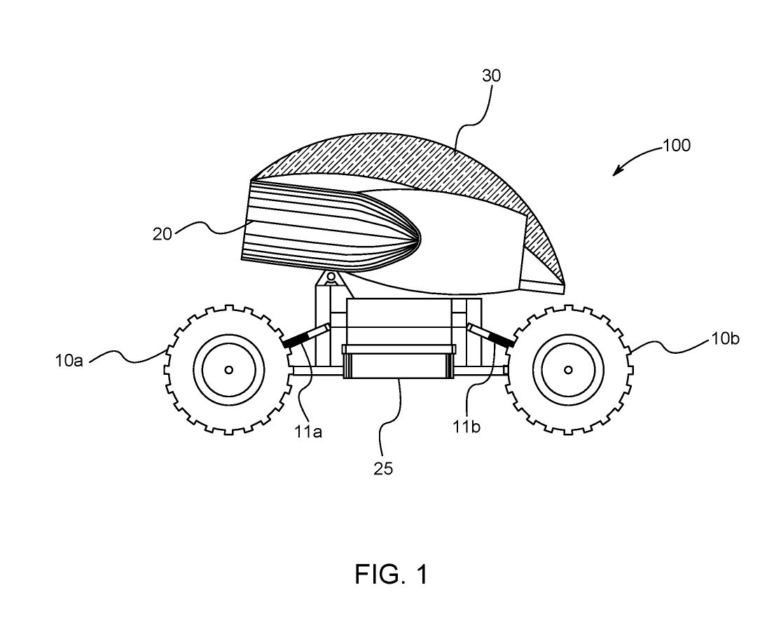

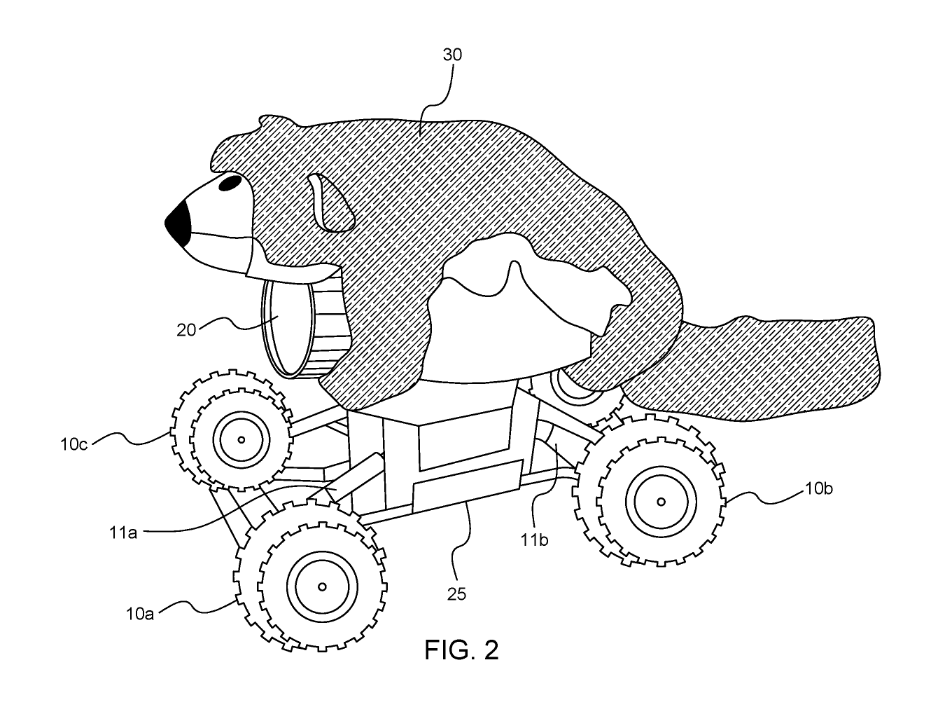

In reference to FIG. 1, a side view of the Hunting Decoy 100 is depicted. The side view provides a clear view of a Speaker 20 that is implemented on a motorized base. The Speaker 20 emits sounds and preferably animal calls associated with various animals. These sounds are stored in memory or a database within the hunting decoy 100. The Speaker 20 is activated through the use of a remote control, not shown. The remote control also controls the movement of the Hunting Decoy 100 over terrain. Other aspects of the Hunting Decoy 100 include a wheelbase with Wheels 10a, 10b shown in FIG. 1. The Hunting Decoy 100 further includes a suspension system shown at 11a, 11b. This wheelbase 10a, 10b and suspension 11a, 11b allows the movement of the hunting decoy over a surface. Further the hunting decoy is covered with a Faux Animal 30 as more clearly shown in FIG. 2. FIG. 1 shows the Speaker 20 exposed in the upper components of the Hunting Decoy 100. Further a Scent Emitter 25 is shown in the motorized base portion. This scent emitter 25 emits a scent as the hunting decoy traverses over a surface.

FIG. 2 shows a perspective view of the Hunting Decoy 100 where the Faux Animal 30 is more detailed. This particular animal is usually associated with the particular game that the hunter is trying to attract. Further the Speaker 20 is shown below the Faux Animal 30 giving the indication that the sounds are emitted by the Faux Animal 30. During use a user controls this device through remote control and can control all aspects of movement, emitting of sounds and emission of scents. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A hunting decoy comprising:
a. motorized base;
b. a speaker, where the speaker emits sounds and is mounted on the motorized base;
c. a scent emitter within the motorized base;
d. a faux animal covering; and
e. a set of wheels.

2. The hunting decoy according to claim 1, where the set of wheels include four wheels.

3. The hunting decoy according to claim 1, where the sounds include a plurality of predetermined animal calls.

4. The hunting decoy according to claim 1, where the motorized base is electrically powered.

5. The hunting decoy according to claim 1, further including a suspension system.

6. The hunting decoy according to claim 1, further including a remote control device to control movement of the hunting decoy over a terrain.
